(19) United States
(12) Patent Application Publication
(10) Pub. No.: US 2026/0360630 A1
(43) Pub. Date: Nov. 12, 2026

(54) TEXTILE-BASED SUPERCAPACITOR ELECTRODE CONTAINING CHALCOGENIDE NANOCOMPOSITES, MANUFACTURING METHOD THEREFOR, AND PSEUDOCAPACITOR INCLUDING SAME

(71) Applicant: KOREA UNIVERSITY RESEARCH AND BUSINESS FOUNDATION, Seoul (KR)

(72) Inventors: Jinhan CHO, Seoul (KR); Woojae CHANG, Seoul (KR)

(73) Assignee: KOREA UNIVERSITY RESEARCH AND BUSINESS FOUNDATION, Seoul (KR)

(21) Appl. No.: 19/137,158

(22) PCT Filed: Sep. 25, 2023
(86) PCT No.: PCT/KR2023/014669

§ 371 Date: Jun. 9, 2025

(30) Foreign Application Priority Data
Dec. 9, 2022 (KR) 10-2022-0171536

(51) Int. Cl. H01G 11/36; H01G 11/26; H01G 11/86

(52) U.S. Cl. CPC H01G 11/36; H01G 11/26; H01G 11/86

(57) ABSTRACT

The present invention relates to a textile-based pseudocapacitor electrode including a thin film layer containing a chalcogenide nanocomposite formed on a textile support and a plating layer formed on the thin film layer, a manufacturing method therefor, and a pseudocapacitor containing the same.

### TECHNICAL FIELD

The present invention relates to a textile-based pseudocapacitor electrode including chalcogenide nanocomposites, a method of manufacturing the same, and a pseudocapacitor including the same.

### BACKGROUND ART

Pseudocapacitors, which may compensate for the low energy density of conventional electric double layer capacitors (EDLCs), are recognized as a promising power source. In particular, the recent rapid development of portable electronic devices and the explosive increase in their use have strongly stimulated the development of pseudocapacitors that enable higher areal capacitance and energy density while maintaining excellent rate performance and high operational stability. However, most energy storage electrodes are manufactured in the form of thin films on nonporous metal foils, and thus there is an inherent limit to increasing the thickness (or loading amount) of active materials because the charge resistance increases as the electrode thickness increases. To solve this problem, several approaches have been proposed, mainly focusing on the use of unique active materials, the manufacture of porous current collectors, and/or the design of optimal electrode structures.

Recently, pseudocapacitor electrodes based on inexpensive, flexible, and conductive textile-based current collectors (TCCs) have emerged as a notable candidate to overcome the shortcomings of pseudocapacitor electrodes with limited 2D surface area. In particular, the three-dimensional porous structure of TCCs consists of numerous interconnected fibrils, which not only provides a large surface area for achieving a high loading amount of active materials per unit area but also facilitates ion diffusion into the active materials. However, to be effectively used as a three-dimensional porous current collector, these insulating fibril-based textiles must first be converted into conductive textiles through uniform application of conductive materials. Various conductive materials, including carbon nanotubes (CNTs) and metal nanowires (NWs), have been incorporated into fibers through conventional physical adsorption processes. However, due to the high contact resistance that is present between adjacent conductive materials (CNTs and NWs), these TCCs exhibit much lower electrical conductivity (sheet resistance>10 Ω·sq⁻¹ and electrical conductivity<200 S·cm⁻¹) than bulk metal foils, which increases the charge transfer resistance between the TCC and the active materials and the internal resistance of the electrode. Although it has been reported that TCCs with an extremely low sheet resistance of about 0.5 Ω sq⁻¹ may be manufactured through multilayer films consisting of tens of Au nanoparticles (NPs), the use of these noble metal NPs may significantly limit their commercial availability.

Electroless deposition method (i.e., chemical reduction deposition method) through the reduction of metal ions in a precursor solution has also been used to manufacture high-performance TCCs. Although electroless-deposited metal textiles may have higher electrical conductivity than carbon-containing textiles or carbon cloth, they still exhibit lower electrical conductivity than bulk metal foils because of the presence of organic impurities in the metal precursors. At the same time, the nonuniform metal coating reduces the high specific surface area of the pristine textile and limits the charge transfer efficiency. As a result, the previously reported approach has many difficulties in fully utilizing the advantages of TCCs.

Although a TCC may be successfully manufactured by some innovative approaches, it should be noted that the coating quality of the active material (i.e., pseudocapacitance material) on the TCC also significantly affects the overall performance of the electrode. Generally, an active slurry consisting of a transition metal oxide and additives (i.e., conductive carbon materials and insulating polymer binders) is deposited on the TCC to complete a pseudocapacitor electrode. However, due to the unstable interfacial bonding between individual components, there is a limitation in uniformly depositing an active material over the entire area of the TCC. In particular, the introduced polymer binder significantly limits the charge transfer at the TCC/active material and active material/active material interfaces. As an alternative, pseudocapacitance materials have been directly deposited on the conductive TCCs through hydrothermal and/or electroless deposition without the assistance of a polymeric binder. However, in most cases, the above-mentioned deposition processes (hydrothermal or electroless deposition) are carried out on the TCC without deeply considering the interfacial interaction between the TCC and the pseudocapacitance material. From this perspective, one of the most challenging approaches is to completely convert all the insulating fibrils within the textile into bulk metal-like conductive fibrils (for current collectors) through uniform coating of the conductive material. In addition, the high-energy pseudocapacitance material need to be uniformly and densely coated to the fibril conductors formed through favorable interfacial interaction-mediated approaches.

### DISCLOSURE

### Technical Problem

The present invention provides a high-capacity and flexible textile-based pseudocapacitor electrode, which ensures both high electrochemical performances and mechanical stability, the textile-based pseudocapacitor electrode including a thin film layer including chalcogenide nanocomposites formed on a textile support; and a plating layer formed on the thin film layer.

However, the technical problems to be solved by the present invention are not limited to the above-mentioned problems, and other problems that are not mentioned will be clearly understood by those skilled in the art from the description below.

### Technical Solution

The present invention provides a textile-based pseudocapacitor electrode including: a thin film layer including a chalcogenide nanocomposite formed on a textile support; and a plating layer formed on the thin film layer.

The chalcogenide nanocomposite may be a chalcogenide nanoparticle combined with an organic compound.

The chalcogenide nanoparticle may be a copper (II) sulfide.

The organic compound may be an organic compound containing a sulfur-containing functional group, or an organic compound containing both a sulfur-containing functional group and a nitrogen-containing functional group.

The thin film layer may have a thickness of 20 nm to 200 nm.

The plating layer may be a nickel (Ni) plating layer.

A nickel cobalt (NiCo) plating layer may be additionally formed on the nickel (Ni) plating layer.

As one embodiment of the present invention, a method of manufacturing a textile-based pseudocapacitor electrode is provided, including: (a) a step of immersing a textile support in a solution containing an organic compound to produce a textile support coated with an organic compound; (b) a step of immersing the textile support coated with the organic compound in a solution containing chalcogenide nanoparticles and then performing a ligand exchange reaction to form a thin film layer containing chalcogenide nanocomposites in which organic compound is bound to a chalcogenide nanoparticles; and (c) a step of forming a plating layer on the previously formed thin film layer through electroplating.

In Step (c), the plating layer is a nickel (Ni) plating layer, and the method may further include (d) a step of additionally forming a nickel cobalt (NiCo) plating layer on the nickel (Ni) plating layer.

As another embodiment of the present invention, a pseudocapacitor including the electrode is provided.

### Advantageous Effects

The textile-based pseudocapacitor electrode according to the present invention includes a thin film layer including chalcogenide nanocomposites formed on a textile support; and a plating layer formed on the thin film layer.

Therefore, as a high-capacity and flexible textile-based pseudocapacitor electrode, it has the advantage of ensuring both high electrochemical performances and mechanical stability.

### DESCRIPTION OF DRAWINGS

FIG. 1 shows a schematic diagram illustrating the manufacture of NiCo-electroplated textile (EPT) as a pseudocapacitor electrode through a chalcogenide nanoparticle assembly-based electroplating process.

FIG. 2A shows the molecular structure of a tetraoctylammonium bromide (TOABr) ligand and a transmission electron microscope (TEM) image of TOABr-CuS nanoparticles with a diameter of approximately 8 nm. The inset of the TEM image shows the lattice spacing (d) of ~2.7 Å, corresponding to the (006) plane of CuS. FIG. 2B shows the UV-vis absorbance spectra of (TOABr-CuS NP/cysteamine (Cys))ₙ multilayers coated onto quartz glass as a function of the bilayer number (n). The inset shows the absorbance at a wavelength of 200 nm, indicating the linear growth of multilayers. FIG. 2C shows the frequency (−ΔF, left axis) and mass change (Δm, right axis) of (TOABr-CuS NP/Cys)ₙ multilayers with an increasing bilayer number obtained from a quartz crystal microbalance (QCM) analysis. FIG. 2D shows the thickness change of (TOABr-CuS NP/Cys)ₙ multilayers on an Si wafer as a function of the bilayer number (n), measured from the cross-sectional field emission-scanning electron microscopy (FE-SEM) images (inset). FIG. 2E shows the sheet resistance (left axis) and electrical conductivity (right axis) of (TOABr-CuS NP/Cys)ₙ multilayers on Si wafer as a function of the bilayer number (n).

FIG. 3A shows the electrical properties of the (TOABr-CuS NP/Cys)ₙ-coated textile with an increasing bilayer number (n). FIG. 3B shows the planar FE-SEM images of a bare textile (top) and the (TOABr-CuS NP/Cys)₅-coated textile (bottom) at different magnifications. FIG. 3C shows the electrical properties after Ni electroplating at 250 mA cm⁻² for ten minutes. FIG. 3D shows the planar FE-SEM images of Ni-EPT at different magnifications, and FIG. 3E shows the cross-sectional FE-SEM images and the corresponding energy-dispersive X-ray (EDX) mapping images. FIG. 3F shows the X-ray diffraction (XRD) patterns of Ni-EPT and commercial Ni foam. FIG. 3G shows the relative electrical conductivity (σ/σ₀) of Ni-EPT as a function of repeated bending cycles (bending radius ~2.9 mm).

FIG. 4A shows the digital photographs/planar FE-SEM images of a NiCo-EPT electrode at different magnifications, and FIG. 4B shows the cross-sectional FE-SEM images and the corresponding EDX mapping images. FIG. 4C shows a comparison of the XRD patterns of Ni-EPT and NiCo-EPT. FIGS. 4D to 4F show the high-resolution X-ray photoelectron spectroscopy (XPS) spectra of O 1s, Ni 2p, and Co 2p of the NiCo-EPT electrode, respectively.

FIG. 5A shows the cyclic voltammetry (CV) curves of the NiCo-EPT and Ni-EPT electrodes compared at a scan rate of 5 mV·s⁻¹. FIG. 5B shows the CV curves of the NiCo-EPT electrode at various scan rates in the range of 0.5 to 20 mV·s⁻¹. FIG. 5C shows the capacity retention of the NiCo-EPT electrode at a scan rate of 20 mVs⁻¹ for 10,000 cycles. FIG. 5D shows the galvanostatic charge-discharge (GCD) curves of the NiCo-EPT electrode at various current densities in the range of 10 to 100 mA·cm⁻². FIG. 5E shows the comparison of areal capacitance of NiCo-t electrodes electroplated for various times (15 to 60 minutes) at a constant current density (3 mA·cm⁻²) compared with the Ni-EPT electrode at various current densities from 10 to 100 mA·cm⁻².

FIG. 6A shows the digital image of NiCo-EPT and CT for full cell manufacture considering the charge balance. FIG. 6B shows the CV curves of NiCo-EPT and carbonized textile (CT) at a scan rate of 20 mV·s⁻¹. FIG. 6C shows the CV curves of an NiCo-EPT//CT asymmetric full-cell pseudocapacitor (AFP) according to the potential window at a scan rate of 20 mV·s⁻¹. FIGS. 6D and 6E show the CV and GCD curves of the NiCo-EPT//CT AFP at various scan rates and current densities, respectively. FIG. 6F shows the areal capacitance and Coulombic efficiency of the AFP as a function of current density.

### MODES OF THE INVENTION

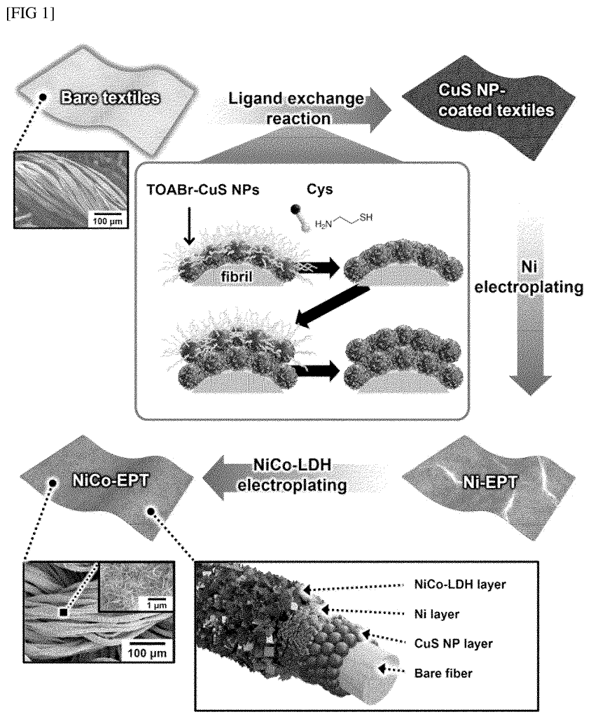

Herein, the present inventors provide a high-performance pseudocapacitor textile electrode manufactured from a chalcogenide (copper sulfide; CuS) nanoparticle (NP) assembly-driven pseudocapacitor electrode (FIG. 1). In the present interfacial interaction-mediated approach, all interfaces in the textile-based pseudocapacitor electrode are covalently and metallically bonded to each other, and additionally, the nano-sized structures further increase the specific surface area of the pristine textile. These advantageous interfacial interactions and structural uniqueness significantly improve the energy storage performance of the pseudocapacitor textile, which exhibits high mechanical flexibility.

In the present invention, tetraoctylammonium bromide (TOABr)-stabilized copper sulfide NPs (i.e., TOABr-CuS NPs) were newly synthesized and layer-by-layer (LbL) assembled with amine (—NH₂)/thiol (—SH)-functionalized cysteamine (Cys) on a highly porous cotton textile. However, due to the relatively low intrinsic conductivity of CuS (the conductivity of bulk CuS at room temperature is ~2×10³ S·cm⁻¹) and the high contact resistance between the CuS NP—NP interface, Ni electroplating was additionally performed on the (TOABr-CuS NP/Cys)ₙ-coated textile to overcome the relatively low electrical conductivity. In this case, the Ni electroplated textile (i.e., Ni-EPT) achieved an electrical conductivity (sheet resistance of ~0.06 Ω·sq⁻¹) similar to that of bulk metals. In particular, the high affinity between the electroplated Ni layer and the NH₂ groups of the outermost Cys layer, as well as the highly uniform adsorption of the conductive CuS NPs on the cotton fibrils, induced the robust and uniform coating of the Ni electroplated layer on the all areas from the exterior to the interior of the textile. Based on this Ni electroplated TCC (i.e., Ni-EPT), the pseudocapacitive NiCo layered double hydroxide (LDH) was sequentially electroplated for the textile cathode (i.e., NiCo-EPT). In general, Ni- or Co-based metal oxides/hydroxides have been reported to exhibit much higher theoretical capacitances than the conventional pseudocapacitive materials, such as MnOx (i.e., 2,358 F·g⁻¹ for Ni(OH)₂ and 3,108 F·g⁻¹ for Co(OH)₂). Moreover, these bimetallic hydroxides can exhibit higher theoretical capacitances due to multiple redox reactions (Ni²⁺/Ni³⁺ and Co²⁺/Co³⁺) as well as relatively high electrical conductivity (0.1 to 100 S·cm⁻¹). Therefore, in the case of NiCo-EPT, the highly porous structure of fibril fibers was well preserved along with high electrochemical activity, extremely low sheet resistance (~0.06 Ω·sq⁻¹), and high mechanical flexibility. In particular, when the mass loading of the electrodeposited NiCo-LDH increased to 5.12 mg·cm⁻², the areal capacitance of NiCo-EPT significantly increased to 12.2 F·cm⁻², which could be further enhanced by simple multi-stacking of NiCo-EPT (i.e., the areal capacitance of three-stack NiCo-EPT ~28.8 F·cm⁻²). This high areal capacitance outperformed the performance of previously reported textile electrodes. Considering that the interfacial interactions and structural properties within electrodes and the unique electrochemical properties of active materials have a dominant effect on the overall energy performance of electrodes, this approach can provide an important foundation for developing and designing various high-performance energy storage electrodes, including pseudocapacitors.

### Textile-Based Pseudocapacitor Electrode

The present invention provides a textile-based pseudocapacitor electrode including: a thin film layer including chalcogenide nanocomposites formed on a textile support; and a plating layer formed on the thin film layer.

First, the textile-based pseudocapacitor electrode according to the present invention includes a textile support. The textile support is formed by weaving the plurality of fibers that cross each other, forming plurality of pores at the point of intersection. These fibers are long, thin, and softly bendable linear objects, and may include both natural and synthetic fibers. Therefore, by weaving natural fibers or synthetic fibers alone, or by blending these fibers, the textile support exhibit flexibility. Specifically, the fibers may be one or more selected from the group consisting of cotton, polyester, nylon, and acrylic fibers, but are not limited thereto.

Next, the textile-based pseudocapacitor electrode according to the present invention includes a thin film layer including chalcogenide nanocomposites, which is formed on a textile support and may be coated through layer-by-layer (LbL) assembly or deposition.

The chalcogenide nanocomposites may be chalcogenide nanoparticles combined with an organic compound. At this time, the organic compound is replaced by performing a ligand exchange reaction, and may have a smaller volume than the organic ligand before performing the ligand exchange reaction.

Specifically, the chalcogenide-based nanoparticles may be copper (II) sulfide or CuS. In addition, the organic compound may be one that contains a sulfur-containing functional group, or one that contains both a sulfur-containing functional group and a nitrogen-containing functional group. The sulfur-containing functional group may be a thiol, sulfide, disulfide group, or similar, while the nitrogen-containing functional group may be an amine, imine groups, and others. More specifically, the organic compound may preferably include both a sulfur-containing functional group and a nitrogen-containing functional group, but is not limited thereto. Accordingly, the organic compound may be one or more selected from the group consisting of cysteamine, cysteine, cystamine, and cystine, all of which inherently include a sulfur-containing functional group, enabling stable adsorption of CuS nanoparticles. In other words, the organic compound essentially includes a sulfur-containing functional group, but tris(2-aminoethyl)amine (TREN) or diethylenetriamine (DETA), which contains only a nitrogen-containing functional group (particularly, an amine group) without a sulfur-containing functional group, has a problem that it is easily dissociated in such a solution due to the formation of strong complexes between Cu ions and the organic compound (i.e., TREN or DETA) having a high density of amine groups per carbon.

The thin film layer may be formed by multiple coated layers through LbL assembly or deposition, and the number of thin film layers may be 1 to 20 layers, preferably 2 to 10 layers. Accordingly, the thickness of thin film layer may range from 20 nm to 200 nm. As the thickness of the thin film layer increases, the sheet resistance decreases while the electrical conductivity increases.

Next, the textile-based pseudocapacitor electrode according to the present invention includes a plating layer, which is formed on the thin film layer and may be formed through electroplating of a nickel (Ni)-based metal oxide/hydroxide. Specifically, the plating layer may be a nickel (Ni) plating layer.

Meanwhile, the thickness of the plating layer may range from 200 nm to 1,000 nm, which may be controlled by adjusting the current density and time during electroplating, and at such a thickness, it can be uniformly deposited on all fibrils within the textile without pore blockage.

In addition, a nickel-cobalt (NiCo) plating layer may be additionally formed on the nickel (Ni) plating layer, and this may also be formed through electroplating of a nickel (Ni) and cobalt (Co)-based metal oxide/hydroxide.

Likewise, the thickness of the nickel-cobalt (NiCo) layer may range from 200 nm to 1,000 nm, which may be controlled by adjusting the current density and time during electroplating, and at such a thickness, it can be uniformly deposited on all fibrils within the textile without pore blockage.

### Method of Manufacturing Textile-Based Pseudocapacitor Electrode

The present invention provides a method of manufacturing a textile-based pseudocapacitor electrode, including: (a) a step of immersing a textile support in a solution containing an organic compound to produce a textile support coated with an organic compound; (b) a step of immersing the textile support coated with the organic compound in a solution containing chalcogenide nanoparticles and then performing a ligand exchange reaction to form a thin film layer containing chalcogenide nanocomposites in which chalcogenide nanoparticles are combined with an organic compound; and (c) a step of forming a plating layer on the thin film layer through electroplating.

First, the method for manufacturing a textile-based pseudocapacitor electrode according to the present invention includes a step [Step (a)] of immersing a textile support in a solution containing an organic compound to produce a textile support coated with an organic compound.

Since the textile support and the organic compound have been described above, repetitive description will be omitted.

Next, the method for manufacturing the textile-based pseudocapacitor electrode according to the present invention includes a step [Step (b)] of immersing the textile support coated with the organic compound in a solution containing chalcogenide nanoparticles and then performing a ligand exchange reaction to form a thin film layer containing chalcogenide nanocomposites in which chalcogenide nanoparticles are combined with an organic compound.

Since the thin film layer containing the chalcogenide nanocomposites in which chalcogenide nanoparticles are combined with an organic compound has been described above, repetitive description will be omitted.

The solution containing the chalcogenide nanoparticles is a solution containing the chalcogenide nanoparticles and an organic ligand, wherein the organic ligand may have a larger volume than the organic compound after performing the ligand exchange reaction. Specifically, the organic ligand may be one or more selected from the group consisting of tetra-n-octyl ammonium bromide, tetra-n-butyl ammonium chloride, benzyl tridecylammonium benzene sulfate, diphenyl didodecyl ammonium hexafluorophosphate, and N-methyl-N-trioctyl-ammonium bis(trifluoromethylsulfonyl)imide, and is preferably tetra-n-octyl ammonium bromide, but is not limited thereto.

The immersion may be performed for about 10 minutes to about 20 minutes, and then washing may be performed to manufacturing a textile support coated with chalcogenide nanoparticles. Next, the textile support coated with the chalcogenide nanoparticles may be additionally immersed in a solution containing an organic compound to perform a ligand exchange reaction. At this time, the additional immersion may be performed for about 1 minute to about 10 minutes, and then washing may be performed again. By repeating the above-described processes, the thin film layer may be coated in multiple layers through LbL assembly or deposition.

Next, the method for manufacturing the textile-based pseudocapacitor electrode according to the present invention includes a step [step (c)] of forming a plating layer on the thin film layer through electroplating.

Since the plating layer has been described above, repetitive description will be omitted.

The electroplating is performed using a nickel (Ni)-based metal oxide/hydroxide in an electroplating solution, and may be performed at a current density of 10 mA·cm⁻² to 500 mA·cm⁻² for 1 to 60 minutes.

In addition, the method for manufacturing the textile-based pseudocapacitor electrode according to the present invention may include a step [step (d)] of additionally forming a nickel cobalt (NiCo) plating layer on the nickel (Ni) plating layer.

Since the nickel-cobalt (NiCo) plating layer has been described above, repetitive description will be omitted.

The electroplating is performed using an electroplating solution using a nickel (Ni) and cobalt (Co)-based metal oxide/hydroxide, and may be performed at a current density of 10 mA·cm⁻² to 500 mA·cm⁻² for 1 to 60 minutes.

### Pseudocapacitor

The present invention provides a pseudocapacitor including an electrode including the textile-based pseudocapacitor electrode.

Specifically, the pseudocapacitor according to the present invention includes a separator, a cathode and an anode disposed with the separator therebetween, and an electrolyte in contact with the cathode and the anode, and the textile-based pseudocapacitor electrode may be applied as the cathode. As the anode, a conventional material may be applied, but in the present invention, a carbonized textile (CT) is applied.

Meanwhile, electrochemical capacitors may be classified into three types: electrochemical double layer capacitors (EDLCs), pseudocapacitors, and hybrid capacitors, depending on the energy storage method and the characteristics of the electrode material.

The pseudocapacitor according to the present invention uses a conductive polymer or an oxide material and a carbon material surface-functionalized with a functional group enabling a redox reaction as an electrode material. Meanwhile, the energy storage method of the pseudocapacitor according to the present invention accumulates charges by an adsorption reaction (non-Faraday reaction) accompanied by the movement of electrons and a Faraday reaction by a redox reaction on the electrode surface. In addition to the capacitance accumulated by the Faraday reaction, an electric double layer capacitance is added by the electrostatic adsorption and desorption of electrolyte ions at the interface between the electrode and the electrolyte, so that the pseudocapacitor has a higher capacity and energy density than an electric double layer capacitor (EDLC). Therefore, the pseudocapacitor according to the present invention has an advantage of compensating for the low energy density of a conventional EDLC.

Hereinafter, preferred examples are presented to help understand the present invention. However, the following examples are provided only to help understand the present invention more easily, and the content of the present invention is not limited by the following examples.

### EXAMPLES

Materials: Sodium thiosulfate (Na₂S₂O₃, 99%), nickel (II) chloride hexahydrate (NiCl₂·6H₂O), palladium (II) chloride (PdCl₂, 99%), sodium hypophosphite monohydrate (NaPO₂H₂·H₂O, ≥99%), ammonium chloride (NH₄Cl, ≥99.5%), sodium citrate dihydrate (Na₃C₆H₅O₇·2H₂O, ≥99%), and potassium hydroxide (KOH, 90%) were purchased from Sigma-Aldrich. Copper (II) chloride dihydrate (CuCl₂·2H₂O, ≥99%), tetra-n-octylammonium bromide (TOABr, ≥98%). nickel (II) sulfate hexahydrate (NiSO₄·6H₂O, ≥98%), boric acid (H₃BO₃, ≥99.5%), nickel (II) nitrate hexahydrate (Ni(NO₃)₂·6H₂O, 98%), cobalt (II) nitrate hexahydrate (Co(NO₃)₂·6H₂O, 98.0-102.0%), and tin (II) chloride dihydrate (SnCl₂·2H₂O, 98.0-103.0%) were purchased from Alfa Aesar. Additionally, cysteamine (Cys, ≥95%), and sodium borohydride (NaBH₄, ≥98%) were received from TCI CO., LTD. All chemical reagents were used without further purification.

Synthesis of TOABr-CuS nanoparticles: TOABr-CuS NPs were synthesized in toluene via a two-step reaction. Briefly, 25 mM TOABr dispersed in toluene (80 mL) and 33 mM CuCl₂·2H₂O in deionized water (30 mL) were vigorously mixed for 15 minutes at 40 °C. Thereafter, 12 mmol Na₂S₂O₃ was added and stirred for 15 minutes to make the mixture solution clear. Thereafter, 0.9 M NaBH₄, a reducing agent, in deionized water (10 mL) was poured into the solution. After 30 minutes, the dark brown toluene phase was separated from the mixture and washed several times with 10 mM HCl, 10 mM NH₄OH, and deionized water.

LbL assembly of (TOABr-CuS NP/Cys)ₙ multilayers: Substrates including an Si wafer, an Au-sputtered Si wafer, quartz glass, and a quartz crystal microbalance (QCM) electrode were irradiated with a UV ozone cleaner for 30 minutes. The substrates and bare cotton textile (0.5×3 cm²) were first immersed into a Cys solution (in ethanol, 2 mg mL⁻¹) for 30 minutes to form a robust underlayer, and then washed twice with pure ethanol to remove the weakly adsorbed Cys molecules. The formed Cys-coated substrates were immersed into a TOABr-CuS NP solution (in toluene, 30 mg mL⁻¹) for 30 minutes, and then washed with pure toluene to eliminate the weakly adsorbed NPs. In the next process, TOABr-CuS NP-coated substrates were immersed into a Cys solution for five minutes to replace bulky TOABr ligands with small Cys ligands. After this ligand exchange reaction-induced adsorption process, weakly adsorbed Cys layers were removed by washing with pure ethanol. These processes were repeated until the desired bilayer number (n) of (TOABr-CuS NP/Cys), multilayers was reached.

Manufacture of Ni-EPT: An electroplating solution (Watts bath) was prepared using 240 g. L⁻¹ NiSO₄·6H₂O, 45 g·L⁻¹ NiCl₂·6H₂O, and 30 g·L⁻¹ H₃BO₃ with deionized water. A (TOABrCuS NP/Cys)₅-coated textile (cathode) and a nickel plate (anode) were immersed in the electroplating solution. The electroplating process was performed by adjusting the external current and electroplating time. The formed Ni-EPT was washed several times with deionized water, and then dried in a vacuum oven.

Manufacture of Ni-CRT: Electroless deposition, using chemical reduction of Ni precursors on fibers, was performed by the process described below. A cotton textile having a size of 0.5×3 cm² was first immersed in a sensitizing solution containing 50 mM SnCl₂·2H₂O and 0.15 M HCl (37%) for 10 minutes. After this immersing process, the textile sample was immersed in an activation solution containing 0.6 mM PdCl₂ and 0.03 M HCl. Finally, the sample was immersed in an electroless plating bath maintained at 80 °C, consisting of 240 g. L⁻¹ NaH₂PO₂·H₂O, 45 g·L⁻¹ NiSO₄·6H₂O, 50 g·L⁻¹ NH₄Cl, 30 g·L⁻¹ Na₃C₆H₅O₇·2H₂O, and the pH was adjusted to 9 with a 0.27% NH₄OH solution. After stirring for 120 minutes, the sample was washed with deionized water and dried in a vacuum oven.

Manufacture of NiCo-t: An NiCo-LDH layer was additionally electroplated in a conventional three-electrode electrochemical cell consisting of Ni-EPT, a Pt coil, and Ag/AgCl (3 M NaCl) as a working electrode, a counter electrode, and a reference electrode, respectively. Electroplating was carried out in a growth solution (10 mM Ni(NO₃)₂·6H₂O and 5 mM Co(NO₃)₂·6H₂O in deionized water) at a constant current density of 3 mA·cm⁻² for a given electroplating time. After the process, the electrode was washed with deionized water, and then dried in a vacuum oven. When the electroplating was performed for 15, 30, and 45 minutes, the formed electrodes were named NiCo-15, NiCo-30, and NiCo-45, respectively. In particular, NiCo-60 was named NiCo-EPT, and both are prepared under the same experimental conditions (i.e., electroplating time ~60 minutes). In this case, the thickness of the NiCo-EPT increased up to approximately 1.0 mm after the electroplating process. For the multi-stacked NiCo-EPTs, the upper part of each NiCo-EPT was attached with a silver paste until a desired stacking number was reached. After this process, the upper part of the stacked NiCo-EPTs was fixed with epoxy.

Manufacture of carbonized textile (CT): A cotton textile was heated at 100 °C for 30 minutes to remove residual moisture. In the following process, the heating temperature was increased up to 950 °C at a rate of 3 °C min⁻¹, and then maintained for three hours. This process was carried out in a furnace under a nitrogen atmosphere. After cooling to ambient temperature, the CT was taken out of the furnace. In this case, the formed CT exhibited a sheet resistance of 9 Ω·sq⁻¹.

Manufacture of asymmetric full-cell pseudocapacitor (AFP): The NiCo-EPT and CT constituted a cathoe and an anode of an AFP, respectively. The area (or mass) ratio of the cathode and the anode was adjusted according to the following charge balance equations:

$$q = C \times Δ E \times S$$

$$\frac{{S}^{+}}{{S}^{-}} = \frac{{C}^{-} Δ {E}^{-}}{{C}^{+} Δ {E}^{+}}$$

Here, q, C, ΔE, and S refer to the stored charge, areal or specific capacitance (F·cm⁻² or F·g⁻¹), potential window (V) during the CV or GCD operation, and area (cm²) or mass (g) of the active material, respectively. The areal ratio of the NiCo-EPT and CT calculated by the equation was 2.54:1.

Characterization: The crystal structure and size distribution of TOABr-CuS NPs was investigated by high-resolution transmission electron microscopy (HR-TEM) (Tecnai 20, FEI). Surface morphology and energy-dispersive X-ray (EDX) mapping were observed using a field emission-scanning electron microscope (FE-SEM) (Quanta 250 FEG, FEI). The UV-vis absorbance spectra of multilayers on quartz glass were recorded using Lambda 365 (Perkin Elmer) within a wavelength range of 200 to 1000 nm. The mass change (Δm, μg·cm⁻²) of each layer was quantitatively calculated from the frequency change (ΔF, Hz) from QCM (QCM 200, SRS) using the Sauerbrey equation as follows:

$$Δ F ( Hz ) = - \frac{2 {F}_{0}^{2}}{A \sqrt{{ρ}_{q} {μ}_{q}}} \times Δ M$$

Here, F₀ indicates the resonant frequency of the fundamental mode of the crystal (5 MHZ). A, ρ_{q}, and μ_{q} refer to the electrode surface area (cm²), density (2.65 g. cm⁻³), and shear modulus (2.95×10¹¹ g·cm⁻¹s⁻²) of the QCM electrode, respectively. Considering each value, the equation may be simplified to the following equation:

−ΔF=56.6×ΔM

A Fourier transform infrared spectroscopy (FTIR) analysis of multilayers on an Au-sputtered Si wafer was conducted using Cary 600 (Agilent Technologies) operating in an advanced grazing angle (AGA) mode with at a 4 cm⁻¹ resolution, and the obtained data was plotted using spectrum analysis software (OMNIC, Thermo Fisher Scientific). XRD patterns were obtained using a SmartLab instrument (Rigaku) with Cu-Kα radiation. An X-ray photoelectron spectroscopy (XPS) analysis was performed by X-TOOL (ULVAC-PHI) with monochromatic Al-Kα radiation as the excitation source. The sheet resistance was measured using the four-probe measurement method with Loresta-GP MCP-T610 (Mitsubishi Chemical Analytech).

Electrochemical measurements: All electrochemical measurements were carried out with an Ivium-n-Stat electrochemical workstation (Ivium Technologies). The electrochemical performance of all single electrodes was measured in a three-electrode cell system, and the performance of AFPs was measured in a two-electrode cell system. In the three-electrode configuration, all single electrodes (active area ~0.5×1.5 cm²), Pt mesh, and Hg/HgO (1M NaOH) were used as the working electrode, counter electrode, and reference electrode, respectively. 6 M KOH was used as an electrolyte for the three-electrode cell system and the two-electrode cell system. Electrochemical impedance spectroscopy (EIS) measurements were performed in the frequency range of 10⁵ to 0.1 Hz with a perturbation amplitude of 0.01 V.

The capacitance (C) values of the electrodes were calculated from the GCD discharge profiles according to the following equation:

$$C = \frac{I Δ t}{S ΔV}$$

Here, I, Δt, and ΔV refer to the applied current (A), discharging time(s), and driving voltage range (V), respectively. The variable S indicates the area (cm²), mass (g), or volume (cm³) of the active material.

The Warburg impedance coefficient (σ_{w}) was obtained from the slope values in the following equation:

Z′=Rₛ+R_{ct}+σ_{w}ω^{-0.5}

Here, ω indicates angular frequency

### Example 1: Conductive Fibers Using LbL-Assembled CuS NP Multilayers

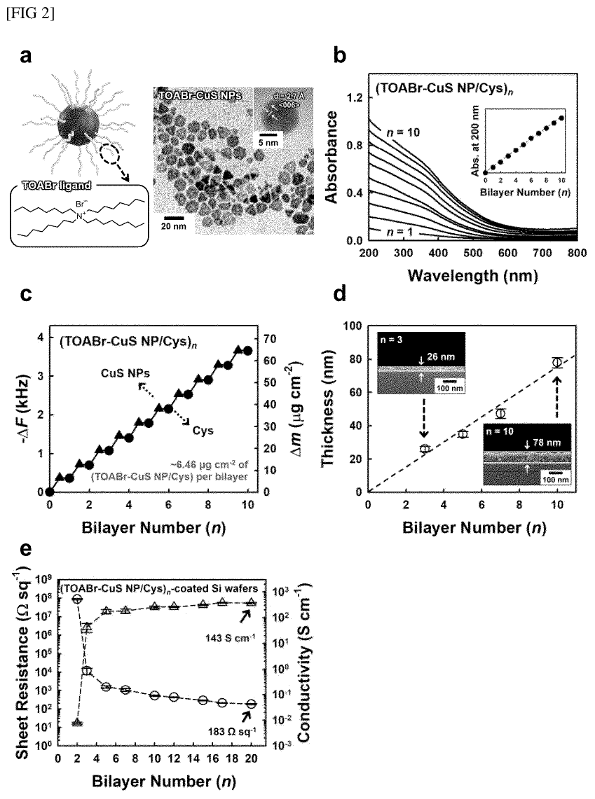

To manufacture a conductive cotton textile, TOABr-CuS NPs with a diameter of approximately 8 nm were first synthesized using non-noble metals in nonpolar media (FIG. 2A). These bulky TOABr ligands (M_{w}≈546 g·mol⁻¹) loosely bound to the surface of CuS NPs could be easily replaced by small Cys molecular ligands (M_{w}≈77 g·mol⁻¹) in organic media due to the higher affinity between the NH₂/SH groups of Cys and the bare surface of CuS NPs. This phenomenon is critical in that TOABr-CuS NPs can be successively assembled with Cys molecules via repetitive ligand exchange reactions during LbL deposition, and additionally, the separation distance between vertically adjacent CuS NP layers can be considerably shortened by the Cys molecular ligands, resulting in a significant decrease in the contact resistance between adjacent CuS NPs.

To confirm these possibilities, the adsorption mechanism of LbL-assembled (TOABr-CuS NP/Cys)ₙ multilayers was further investigated using FT-IR spectroscopy as a function of the bilayer number (n). As a result, when TOABr-CuS NPs were deposited on the Cys-coated substrate (i.e., n=0.5), C—H stretching peaks from the bulky alkyl chains of TOABr ligands were generated at 2850 to 2950 cm⁻¹. When Cys ligands were further deposited on the TOABr-CuS NP-coated substrate (n=1.0), the C—H stretching peaks significantly decreased. Therefore, the alternating deposition of TOABr-CuS NPs and Cys ligands caused repeated generation and disappearance of the C—H stretching peaks from the TOABr ligands when the outermost layer was periodically changed from TOABr-CuS NPs to Cys and vice versa. These results clearly imply that LbL-assembled (TOABr-CuS NP/Cys)ₙ multilayers could be manufactured using the ligand exchange reaction between bulky TOABr and small Cys ligands.

Based on these results, the present inventors investigated the adsorption behavior of LbL-assembled (TOABr-CuS NP/Cys)ₙ multilayers on various flat substrates using UV-vis spectroscopy, a quartz crystal microbalance (QCM), and FE-SEM (FIG. 2B to 2D). First, from the UV-vis absorbance data, the LbL-assembled multilayers qualitatively exhibited linear growth with an increasing bilayer number, suggesting complementary interactions between TOABr-CuS NPs and Cys and vertical growth of multilayers (FIG. 2B). In addition, the present inventors quantitatively investigated the loading amount of the (TOABr-CuS NP/Cys)ₙ multilayers using QCM electrodes. FIG. 2C shows the frequency change (−ΔF) of alternatively deposited TOABr-CuS NPs and Cys ligands, which resulted in a frequency of approximately 365±7 Hz per (TOABr-CuS NP/Cys) bilayer (389 Hz for TOABr-CuS NPs and −24 Hz for Cys). When converting ΔF to mass change (Δm) using the Sauerbrey equation, Δm corresponds to 6.46 μg·cm⁻² per bilayer (6.88 μg·cm⁻² for TOABr-CuS NPs and −0.42 μg·cm⁻² for Cys). In particular, a slight decrease in the frequency or mass change during the deposition of Cys means that the bulky native TOABr ligands bound to the CUS NPs were replaced by smaller Cys molecules. Additionally, these results clearly demonstrate that only one Cys layer is present between vertically adjacent CuS NP layers after LbL deposition. Although the present inventors previously reported that NH₂-rich monomolecular ligands such as TREN or DETA could be used as effective organic materials for ligand exchange-induced LbL assembly of TOABr-Au NPs, the TOABr-CuS NPs were easily dissociated in these solutions due to the formation of strong complexes between Cu ions and the organic materials (i.e., TREN or DETA) with a high-density of NH₂ groups per carbon. As a result, CuS NPs could not be easily LbL-assembled with TREN or DETA ligands. In contrast, it should be noted that Cys ligands with only one NH₂ group and one SH group can stably induce the adsorption of TOABr-CuS NPs. By increasing the bilayer number from 3 to 10, the total film thicknesses of the (TOABr-CuS NP/Cys), multilayers increased from approximately 26 to 78 nm, forming a highly uniform and nanoporous structure (FIG. 2D).

Based on these results, the electrical characteristics of the (TOABr-CuS NP/Cys)ₙ multilayer film on Si wafers were investigated as a function of the bilayer number (n) (FIG. 2E). As the bilayer number increased from 2 to 20, the sheet resistance of the multilayer film significantly decreased from approximately 8.7×10⁷ to 183 Ω·sq⁻¹, and additionally, the electrical conductivity (σ) increased from 7.7×10⁻³ to 365 S·cm⁻¹ without any additional chemical, physical, and/or thermal treatment. Although the electrical conductivity of the LbL-assembled CuS NP multilayers was much inferior to that of bulk pure Cu (i.e., the electrical conductivity of bulk Cu ≈5.96×10⁵ S·cm⁻¹ at 20 °C), it should be noted that manufacturing conductive films from spherical-type CuS-based NPs with high contact resistance at room temperature is very challenging and has rarely been reported by other research groups.

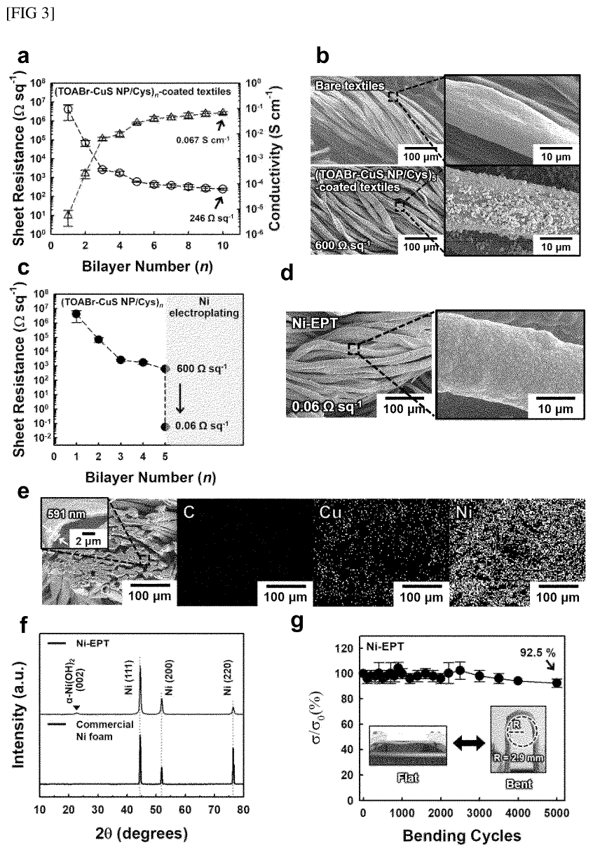

Based on these results, the present inventors' approach was expanded to a 3D porous cotton textile consisting of hydroxyl (OH) group-functionalized cellulose fibrils. Similarly, TOABr-CuS NPs were assembled on the Cys-coated textile through the ligand exchange reaction between TOABr and Cys ligands. As the bilayer number of (TOABr-CuS NP/Cys)ₙ multilayers increased from 1 to 10, the sheet resistance of the textile decreased from ~10⁷ to 246 Ω·sq⁻¹, and its electrical conductivity increased from ~10⁻⁵ to 6.7×10⁻² S·cm⁻¹ (herein, the measured electrical conductivity was calculated by including the thickness of a 620 μm-thick cotton textile) (FIG. 3A). The formed multilayers were densely deposited on all fibrils within the cotton textile without any pore blockage (FIG. 3B). Additionally, the (TOABr-CuS NP/Cys)₅-coated textile exhibited stable mechanical and electrical characteristics under repeated external stimuli.

### Example 2: Highly Conductive TCC Using Ni Electroplating

However, it should be noted that manufacturing highly conductive CuS NP-coated textiles with extremely low sheet resistance (<10⁻¹ Ω·sq⁻¹) through subsequent LbL deposition of CuS NPs is difficult due to their intrinsically low electrical conductivity. To overcome this critical problem and further improve process efficiency, Ni electroplating was additionally performed on the Cus NP-coated textile. In this case, the present inventors expected that the sheet resistance of ≈600 Ω·sq⁻¹ measured from the (TOABr-CuS NP/Cys)-coated textile with five bilayers would be sufficiently suitable for Ni electroplating. To confirm this possibility, the (TOABr-CuS NP/Cys)₅-coated textile was electroplated, and the change in sheet resistance was observed at various external current densities and electroplating times (FIG. 3C). As the current density and electroplating time increased from 50 mA·cm−2 and 2 min to 250 mA·cm−2 and 10 min, the sheet resistance of the Ni electroplated textiles decreased to 0.06 Ω·sq⁻¹.

Based on these results, the Ni electroplating condition of 250 mA·cm⁻² for 10 min were used to produce Ni-EPT. As confirmed by FE-SEM (FIG. 3D) and EDX mapping (FIG. 3E) images of Ni-EPT, the electroplated Ni component was uniformly deposited on all the fibrils from the outermost surface to the central region of the textile with a thickness of 591 nm without Ni agglomeration. This was entirely attributed to both the formation of uniform conductive seed layers (i.e., CuS NP multilayers) on the cotton fibrils and the favorable interfacial interactions between the outermost Cys layer and the Ni precursor ions.

The crystal structure of the Ni-EPT layer was analyzed using XRD analysis. The XRD patterns of Ni-EPT exhibited (111), (200), and (220) reflection peaks located at 44.6°, 51.8°, and 76.4°, respectively, which were attributed to the characteristic peaks of face-centered cubic (fcc) Ni. Additionally, a minor (002) peak assigned to α-Ni(OH)₂ was observed due to partial surface oxidation. These results were almost consistent with that of commercial Ni foams (FIG. 3F), suggesting that the insulating cotton textile was converted into a bulk Ni-like conductive textile through the LbL assembly and Ni electroplating processes. Furthermore, this conductive layer maintained extremely low sheet resistance, retaining 92.5% of the initial conductivity, after 5000 cycles of repetitive mechanical bending tests (FIG. 3G). These results suggest that Ni-EPT formed through the present inventors' interfacial interaction-mediated approach could be used as a TCC having excellent mechanical and electrical stability with bulk metal-like conductivity.

### Example 3. Pseudocapacitive Textile Using Pseudocapacitive Electroplating

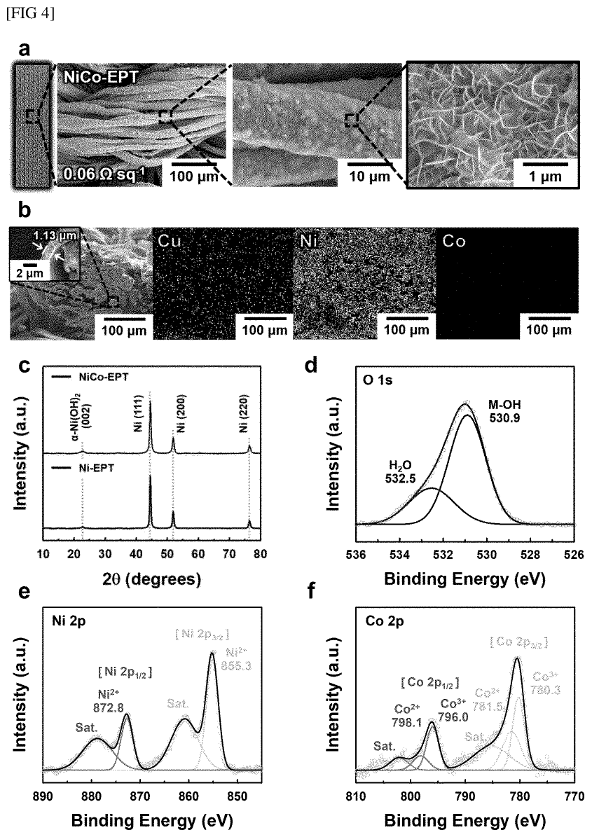

To manufacture a pseudocapacitive textile cathode with enhanced energy storage performance, an NiCo-LDH material exhibiting high theoretical capacity was additionally electroplated on the Ni-EPT current collector at a current density of 3 mA·cm⁻² for different electroplating times (i.e., NiCo-t). In this case, NiCo-LDH was uniformly electroplated on the respective fibrils as the electroplating time was increased from 15 to 60 min, and the mass loading increased almost linearly from 1.27 to 5.12 mg·cm⁻² according to the corresponding electroplating time (i.e., from 15 to 60 min). In particular, in the case of an electroplating time of 60 min (designated as NiCo-60, specifically NiCo-EPT), the formed NiCo-LDH layer exhibited a thickness of 539 nm (i.e., calculated from both the total thickness of 1.13 μm and the Ni layer thickness of 591 nm) and was uniformly deposited on all fibrils within the textile without any reduction in porosity despite the relatively high mass loading (5.12 mg·cm⁻²). The results were confirmed by FE-SEM and EDX mapping images (FIGS. 4A and 4B). Additionally, this NiCo-EPT exhibited a considerably low sheet resistance of approximately 0.06 Ω sq⁻¹, which was similar to that of Ni-EPT, and maintained relatively stable electrical conductivity, as confirmed by the mechanical stability test.

As shown in FIG. 4C, the XRD pattern of NiCo-EPT exhibited reflection peaks of (111), (200), and (220) originating from Ni-EPT, suggesting that the NiCo-LDH layer possessed an amorphous phase. In particular, it has been reported that the amorphous structure of NiCo-based compositions have many defects and long-range disordered characteristics so that it can provide an easier pathway for intercalation/deintercalation of charges in the electrolyte. As a result, this amorphous structure of NiCo-LDH could accelerate the redox reaction, resulting in an improvement in the charge transfer rate of the textile electrode. The chemical states of the bonded elements and the valence state of NiCo-EPT were also investigated using XPS analysis. In the case of the O 1s spectrum, the main peak at 530.9 eV was generated by metal hydroxyl groups (Ni—OH and Co—OH), and the other peak at 532.5 eV originated from the adsorbed water molecules (FIG. 4D). Peaks at the binding energy of 855.3 (for Ni 2p_{3/2}) and 872.8 eV (for Ni 2p_{1/2}) and two satellite peaks at 860.9 and 878.8 eV were observed in the high-resolution spectra of Ni 2p (FIG. 4E). The deconvoluted XPS spectrum of Co 2p indicated the presence of mixed Co²⁺ and Co³⁺ (FIG. 4F). In addition, the Ni/Co atomic ratio on the surface of the formed 539 nm-thick NiCo-LDH layer was estimated to be approximately 1.32:1 in the XPS spectrum area.

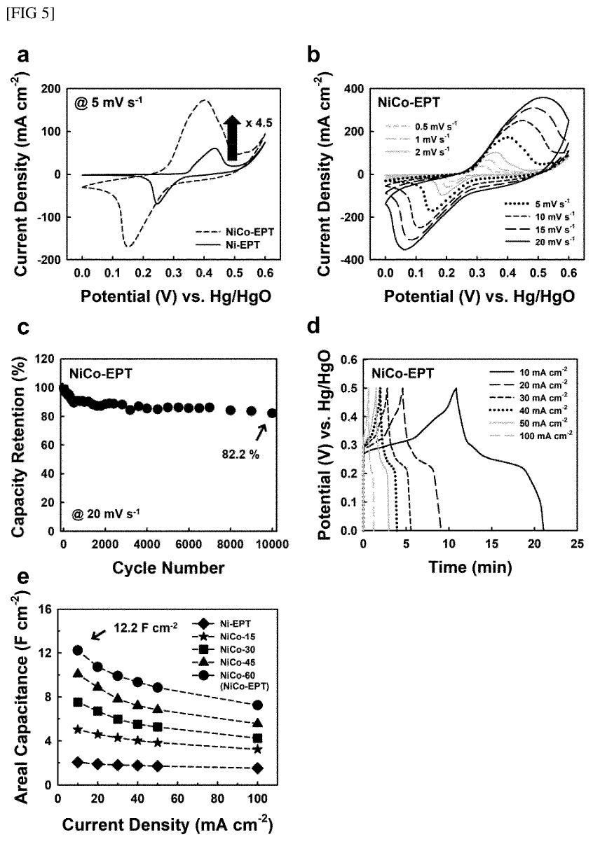

Based on these results, the electrochemical performance of NiCo-EPT as a cathode for pseudocapacitors was evaluated using a three-electrode cell configuration in a 6 M KOH electrolyte. Cyclic voltammetry (CV) scans of the electrode were measured at a scan rate of 5 mV·s⁻¹ (FIG. 5A). First, the integrated CV area of NiCo-EPT in the potential range of 0 to 0.6 V (vs the Hg/HgO reference electrode) was much larger than that of bare Ni-EPT, suggesting that the overall capacitance of NiCo-EPT was mainly induced by the electroplated NiCo-LDH layer. Additionally, the NiCo-EPT electrode displayed a pair of redox peaks generated from the reversible Faradaic reaction during electrochemical measurements. These electrochemical reactions are represented by the following equations:

Ni(OH)₂+OH⁻↔NiOOH+H₂O+e⁻

Co(OH)₂+OH⁻↔CoOOH+H₂O+e⁻

CoOOH+OH⁻↔CoO₂+H₂O+e⁻

As the NiCo-LDH electroplating time increased, the integrated area of the CV curve gradually increased at a scan rate of 5 mV·s⁻¹, suggesting that the capacitance of the electrode may be controlled by adjusting the electroplating time. In particular, the CV curve of 15 min-NiCo-LDH electroplated textile (i.e., NiCo-15) exhibited a reduction peak at 0.45 V due to the insufficient coating of the current collector, resulting in partial expression of Ni-EPT. All the CV curves of the NiCo-EPT displayed a clear redox pair without notable deformation in the shape at different scan rates ranging from 0.5 to 20 mV·s⁻¹ (FIG. 5B). Additionally, the NiCo-EPT retained 82.2% of its initial capacitance after 10,000 cycles (at a scan rate of 20 mV·s⁻¹), while maintaining the surface morphology without delamination and/or cracking of the NiCo-LDH layer (FIG. 5C).

The galvanostatic charge-discharge (GCD) profile for NiCo-EPT was recorded to evaluate the charge storage capabilities at various current densities ranging from 10 to 100 mA·cm⁻² (FIG. 5D). In this case, all GCD curves had a nonlinear profile showing typical pseudocapacitive behavior, and exhibited good rate performance. In particular, the areal capacitances of NiCo-EPT at current densities of 10 and 100 mA·cm⁻² were estimated to be approximately 12.2 and 7.2 F·cm⁻², respectively, indicating relatively good rate performance, and also exhibited a high Coulombic efficiency of 93.7% and 98.3%, respectively. Additionally, the NiCo-EPT retained 70.8% of its initial capacitance after 5000 cycles of GCD measurement at a current density of 150 mA·cm⁻² with no significant change in the impedance values (Rₛ, R_{ct}, and Z_{w}). In addition, it should be noted that the electroplating time of NiCo-LDH was directly related to the areal capacitance of NiCo-EPT (FIG. 5E). Specifically, when the NiCo-LDH electroplating time was increased from 15 to 60 min, the areal capacitance of the NiCo-t electrode at 10 mA·cm⁻² increased from 5.0 to 12.2 F·cm⁻², which also corresponded to a specific capacitance of 2383 F·g⁻¹ and a volumetric capacitance of 122 F·cm⁻³.

Another noteworthy benefit of the present inventors' approach is that the areal capacitance of NiCo-EPT can be more significantly improved through a simple multi-stacking method. To demonstrate this effect, the electrochemical performance of multi-stacked NiCo-EPT was investigated by CV and GCD at various sweep rates.

As the stacking number (m) was increased up to 3, the current range and integrated CV area of m-NiCo-EPT gradually increased, suggesting an increase in charge storage capability. This phenomenon can also be confirmed by the increased discharge time at a current density of 30 mA·cm⁻², as shown in the GCD profile. Based on these discharge curves (at 30 mA·cm⁻²), the measured areal capacitances were approximately 19.4 F·cm⁻² for the 2-stack NiCo-EPT and 28.8 F·cm⁻² (1875 F·g⁻¹ and 288 F·cm⁻³) for the 3-stack NiCo-EPT, respectively, indicating that they outperformed the areal capacitances of previously reported textile electrodes. More importantly, these multi-stacked NiCo-EPTs still exhibited good rate performance with areal capacitances of 13.6 F·cm⁻² (for the 2-stack NiCo-EPT) and 20.4 F·cm⁻² (for the 3-stack NiCo-EPT), respectively, even at a high current density of 100 mA·cm⁻². Considering that a significant increase in the electrode thickness (i.e., an increase in the mass loading of pseudocapacitive active materials per unit area) may inevitably disturb charge transfer, the present inventors' approach was very sufficient to obtain pseudocapacitive textile electrodes with high areal capacitance, good rate performance, and large area.

### Example 4. Electrochemical Performance of AFP

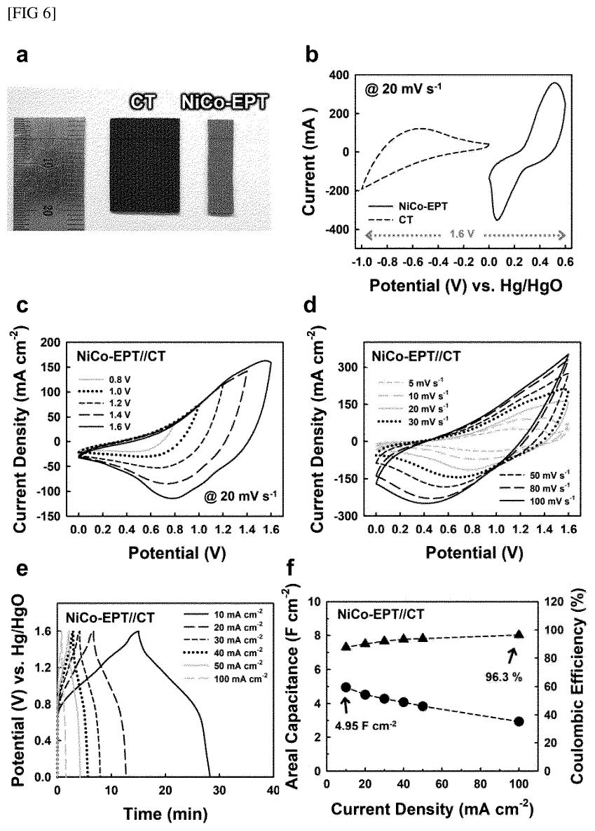

Based on the above results, the present inventors' manufactured an AFP composed of a 1-stacked NiCo-EPT cathode and a corresponding anode. To this end, a CT having a sheet resistance of approximately 6 Ω·sq⁻¹ and a highly porous structure was used as an anode to meet the electrochemical performance of the cathode (i.e., NiCo-EPT). The areal capacitance of CT measured at a current density of 10 mA cm⁻² was approximately 2.4 F·cm⁻². Considering the charge balance (q⁺=q⁻) of each electrode, the area of the CT anode should be approximately 2.5 times larger than that of the NiCo-EPT cathoode to manufacture an AFP (i.e., NiCo-EPT//CT) (FIG. 6A). According to these charge balances and CV curves in the three-electrode system, the NiCo-EPT and CT showed stable electrochemical behavior in the potential ranges of 0 to 0.6 V and −1.0 to 0 V, respectively. Based on these results, the potential window of the AFP could be extended up to 1.6 V in a KOH solution (FIG. 6B). Additionally, the CV curves of the AFP measured at different operation voltage windows ranging from 0.8 to 1.6 V at a scan rate of 20 mV·s⁻¹ exhibited stable pseudocapacitive characteristics with reversible Faradaic reactions (FIG. 6C). The CV curves of the AFP exhibited both EDLC and pseudocapacitive characteristics at various scan rates from 5 to 100 mV·s⁻¹ (FIG. 6D). Additionally, quasi-triangular symmetric GCD profiles from 10 to 100 mA·cm⁻² indicated desirable capacitive features and excellent rate performance (FIG. 6E). In particular, the AFP exhibited high areal (specific and volumetric) capacitances of approximately 4.95 F·cm⁻² (967 F·g⁻¹ and 49.5 F·cm⁻³) and 2.94 F·cm⁻² (574 F·g⁻¹ and 29.4 F·cm⁻³) at current densities of 10 and 100 mA·cm⁻², respectively, and showed an excellent Coulombic efficiency of 96.3% at a current density of 100 mA·cm⁻² (FIG. 6F). These performance values were much higher than those of previously reported 3D substrate-based AFPs. It should be noted that the AFP having the above-mentioned high areal capacitance and rate performance may not be easily realized with other pseudocapacitive cathodes. Therefore, these results clearly demonstrate that the NiCo-EPT-based AFP can potentially be applied to various power applications with high performance.

The present inventors demonstrated that a high-performance 3D fibril-type textile pseudocapacitor with extremely high areal capacitance and good rate performance could be successfully manufactured through a chalcogenide NP assembly-induced electroplating process. For the manufacture of conductive fibers, TOABr-CuS NPs were assembled with NH₂/SH-functionalized Cys molecular ligands on cotton textiles through a ligand exchange reaction, thereby minimizing the separation distance (i.e., contact resistance) between adjacent CuS NPs. An additional Ni electroplating step converted the conductive textile into a metallic textile (≈0.06 Ω·sq⁻¹) that could be directly used as a TCC. In addition, the NiCo-LDH layer was successfully electroplated for the pseudocapacitor cathode, which still maintaining the flexible/porous properties of a pristine cotton textile. Due to its large surface area and bulk metal-like conductivity, the formed NiCo-EPT exhibited a considerably high areal capacitance of 12.2 F·cm⁻² at 10 mA·cm⁻² and a high Coulombic efficiency. Additionally, this high areal capacitance could be further increased up to 28.8 F·cm⁻² through a simple multi-stacking method. These results clearly demonstrate that the NiCo-EPT manufactured through the present inventors' approach can possess high electrical conductivity and maintain a highly porous structure despite the high mass loading of pseudocapacitive components on a TCC (or multi-stacked TCC), thereby producing a high-performance textile cathode with unprecedently high areal capacitance and good rate performance. The present inventors expect that the approach of the present invention can be easily applied to various high-performance electrochemical electrodes including pseudocapacitor electrodes that require a large surface area, high electrical conductivity, and easy charge transfer.

The above description of the present invention is for illustrative purposes only, and those skilled in the art will understand that the present invention can be easily modified into other specific forms without changing the technical idea or essential characteristics of the present invention. Therefore, it should be understood that the above-described embodiments are exemplary in all respects and not restrictive.

1. A textile-based pseudocapacitor electrode comprising:
a thin film layer including a chalcogenide nanocomposite formed on a textile support; and
a plating layer formed on the thin film layer.

2. The electrode of claim 1, wherein the chalcogenide nanocomposite is a chalcogenide nanoparticle combined with an organic compound.

3. The electrode of claim 1, wherein the chalcogenide nanoparticle is copper (II) sulfide.

4. The electrode of claim 1, wherein the organic compound is an organic compound containing a sulfur-containing functional group, or an organic compound containing both a sulfur-containing functional group and a nitrogen-containing functional group.

5. The electrode of claim 1, wherein the thin film layer has a thickness of 20 nm to 200 nm.

6. The electrode of claim 1, wherein the plating layer is a nickel (Ni) plating layer.

7. The electrode of claim 6, wherein a nickel cobalt (NiCo) plating layer is additionally formed on the nickel (Ni) plating layer.

8. A method of manufacturing a textile-based pseudocapacitor electrode, comprising:
(a) a step of immersing a textile support in a solution containing an organic compound to produce a textile support coated with an organic compound;
(b) a step of immersing the textile support coated with the organic compound in a solution containing chalcogenide nanoparticles and then performing a ligand exchange reaction to form a thin film layer containing chalcogenide nanocomposites in which chalcogenide nanoparticles are combined with an organic compound; and
(c) a step of forming a plating layer on the thin film layer through electroplating.

9. The method of claim 8, wherein in Step (c), the plating layer is a nickel (Ni) plating layer, and the method further comprises (d) a step of additionally forming a nickel cobalt (NiCo) plating layer on the nickel (Ni) plating layer.

10. A pseudocapacitor comprising the electrode according to claim 1.
